(19) United States
(12) Patent Application Publication
(10) Pub. No.: US 2014/0160541 A1
(43) Pub. Date: Jun. 12, 2014

(54) HOLOGRAPHIC IMAGE IDENTIFICATION APPARATUS AND METHOD, AND HOLOGRAPHIC IMAGE SELECTIVE RECONSTRUCTION APPARATUS, METHOD AND SYSTEM

(71) Applicant: Electronics and Telecommunications Research Institute, Daejeon (KR)

(72) Inventors: Jae Han KIM, Gwacheon-si Gyeonggi-do (KR); Bong Ho LEE, Daejeon (KR); Won Sik CHEONG, Daejeon (KR); Nam Ho HUR, Daejeon (KR)

(73) Assignee: Electronics and Telecommunications Research Institute, Daejeon (KR)

(21) Appl. No.: 14/099,505

(22) Filed: Dec. 6, 2013

(30) Foreign Application Priority Data
Dec. 7, 2012 (KR) 10-2012-0142164
Dec. 3, 2013 (KR) 10-2013-0149022

(51) Int. Cl. G03H 1/00; G03H 1/22

(52) U.S. Cl. CPC G03H 1/0011; G03H 1/2286
USPC 359/2; 359/10

(57) ABSTRACT

Disclosed is an apparatus for identifying authenticity of a holographic image, which is capable of identifying the authenticity by comparing a holographic image reconstructed by irradiating light having the same characteristic as an irradiation characteristic of a first reference beam used in generating the holographic image with an original image. Accordingly, since an image or a pattern is recorded by using a reference beam having a specific angle and a specific laser wavelength band in making a hologram, replication or copying for forgery is prevented from being easy.

This application claims the benefit of priority of Korean Patent Application Nos. 10-2012-0142164 filed on Dec. 7, 2012 and 10-2013-0149022 filed on Dec. 3, 2013, which is incorporated by reference in its entirety herein.

### BACKGROUND OF THE INVENTION

1. Field of the Invention

The present invention relates to a method for recording a holographic image in a photosensitive material such as a hologram film and determining whether the holographic image is forged.

2. Discussion of the Related Art

A hologram is generated by a method that generates an object beam and a reference beam are generated by using a coherent laser beam and irradiates the generated beams to a hologram photosensitive material such as a silver halide film or a photopolymer film to record an interference fringe.

A holographic recording method includes reflection holography and transmission holography and is determined by an illumination direction of the reference beam. When white light or light having a specific wavelength is illuminated to the hologram generated by such a program by means of an illumination device, the recorded image is reconstructed to observe a stereoscopic recorded image. Making the hologram in related art concentrates on enhancement of a method of reconstructing a clear holographic image by illuminating the reference beam at an appropriate angle.

In this case, only when a direction of light used as an illumination needs to coincide with a direction in recording, the clear holographic image can be reconstructed with maximum efficiency and only when a wavelength of light also coincides with a wavelength of a light source used in recording, the clear image can be reconstructed.

Contrary to this, when the direction of the reference beam and the direction of the illumination do not coincide with each other or a wavelength of the reference beam and a wavelength of illumination light do not coincide with each other, the recorded image is not reconstructed.

Therefore, when such a characteristic is utilized, an image or a pattern which can be observed only at a specific angle or a specific wavelength can be reconstructed and can be utilized as security identification means by using the reconstructed image or pattern. Further, this method can be applied even in recording multiple images in a material under a condition having a different characteristic of the reference beam and thereafter, selectively observing only a desired image by using the illumination device having a wavelength and direction control function.

### SUMMARY OF THE INVENTION

An object of the present invention is to provide a holographic image identification method in which an image is changed depending on an illumination characteristic as a method for preventing forgery by substituting a document or a photograph which is easily forged through duplication or copying.

Further, another object of the present invention is to provide a method that can selectively observe only a desired image by using an illumination device having a wavelength and direction control function after recording multiple images in a material.

In order to achieve the objects, in accordance with an embodiment of the present invention, an apparatus for identifying authenticity of a holographic image may identify the authenticity by comparing a holographic image reconstructed by irradiating light having the same characteristic as an irradiation characteristic of a first reference beam used in generating the holographic image with an original image.

The apparatus for identifying authenticity of a holographic image may include: a light irradiation unit reconstructing the holographic image by irradiating light to the holographic image; a control unit controlling an irradiation characteristic of the light irradiated to the holographic image; and an authenticity judging unit judging the authenticity by comparing the reconstructed holographic image with the original image.

The control unit may control light having the same irradiation angle and wavelength as the first reference beam to a recording material to the holographic image.

The authenticity judging unit may include a reconstructed image acquiring unit acquiring the reconstructed holographic image; and a judgment unit judging the authenticity of the holographic image by judging whether similarity between the acquired holographic image and the original image is equal to or more than a reference value.

The judgment unit may judge the authenticity based on at least one of depth information of the acquired holographic image, object occlusion associated information, and feature point information.

The judgment unit may judge the authenticity of the holographic image by detecting a depth value of a feature point in the acquired holographic image or determine the authenticity of the holographic image based on inter-depth values or inter-placement relationship of a plurality of feature points.

In order to achieve the objects, in accordance with another embodiment of the present invention, a method for identifying authenticity of a holographic image may include identifying the authenticity by comparing a holographic image reconstructed by irradiating light having the same characteristic as a characteristic of a first reference beam used in generating the holographic image with an original hologram image.

In order to achieve the objects, in accordance with yet another embodiment of the present invention, an apparatus for selectively reconstructing a first holographic image including a plurality of holographic images may selectively reconstruct at least one holographic image among the plurality of holographic images by irradiating light by using light irradiation means capable of an irradiation angle and a wavelength of light to a first holographic image generated by using reference beams having different characteristics with respect to a plurality of original images.

The apparatus for selectively reconstructing a first holographic image may include: a light irradiation unit reconstructing the holographic image by irradiating light to the holographic image; and a control unit controlling an irradiation characteristic of the light irradiated to the holographic image, and the control unit may control an irradiation angle and a wavelength of light irradiated to correspond to an irradiation angle and a wavelength of at least one reference beam among the plurality of holographic images included in the first holographic image.

Information associated with the irradiation angle and the wavelength of the reference beam may be received from the outside or input through a user interface and an irradiation angle and a wavelength of light may be controlled based on the received or input information.

The apparatus for selectively reconstructing a first holographic image may code an element associated with reconstruction of the holographic image to provide the coded element as image identification information.

The apparatus for selectively reconstructing a first holographic image may identify the authenticity by comparing a holographic image reconstructed by irradiating light having the same characteristic as an irradiation characteristic of a reference beam used in generating the first holographic image with an original image.

In order to achieve the objects, in accordance with still another embodiment of the present invention, a method for selectively reconstructing a first holographic image including a plurality of holographic images may include selectively reconstructing at least one holographic image among the plurality of holographic images by irradiating light by using light irradiation means capable of an irradiation angle and a wavelength of light to a first holographic image generated by using reference beams having different characteristics with respect to a plurality of original images.

In order to achieve the objects, in accordance with still yet another embodiment of the present invention, a system for selectively reconstructing a first holographic image including a plurality of holographic images may include: a holographic image generation apparatus generating a first holographic image by using reference beams having different characteristics with respect to a plurality of original images; and a holographic image reconstruction apparatus selectively reconstructing at least one holographic image among the plurality of holographic images by irradiating light by using light irradiation means capable of controlling an irradiation angle and a wavelength of light with respect to the generated first holographic image.

The holographic image generation apparatus may provide characteristic information of reference beams used in the plurality of original images to the holographic image reconstruction apparatus and the holographic image reconstruction apparatus controls an irradiation angle and a wavelength of light irradiated to a holographic image based on the reference beam characteristic information.

The holographic image reconstruction apparatus may identify authenticity by comparing a holographic image reconstructed by irradiating light having the same characteristic as an irradiation characteristic of a reference beam used in generating the first holographic image and an original image.

According to an apparatus and a method of holographic image forgery identification, since an image or a pattern is recorded by using a reference beam having a specific angle and a specific laser wavelength band at the time of making a hologram, duplication or copying for forgery is not easy.

Further, since authenticity is determined in spite of the duplication or copying, the forgery is prevented.

Moreover, since an observed image has a unique characteristic according to a reference beam control characteristic, a recorded hologram is applied to an identification card or a money or a document to determine authenticity thereof to be utilized as a security tool and applied in selectively observing a desired image by using an illumination device having a wavelength and direction control function after recording multiple images in a material.

### BRIEF DESCRIPTION OF THE DRAWINGS

FIG. 1 is a block diagram illustrating a holographic image authenticity identification system according to an embodiment of the present invention.

FIG. 2 is a block diagram schematically illustrating a configuration of a holographic image reconstruction apparatus according to an embodiment of the present invention.

FIG. 3 is a conceptual diagram for describing a process in which a laser collimated beam is irradiated to a photosensitive film.

FIG. 4 is a conceptual diagram for describing an operation of a laser light source unit according to an embodiment of the present invention.

FIG. 5 is a diagram for describing a function to control a wavelength (λ) of a reference beam and an angle (θ) with a material of the reference beam.

FIG. 6 is a block diagram schematically illustrating a configuration of a holographic image reconstruction apparatus according to an embodiment of the present invention.

FIG. 7 is a diagram for describing a process in which a holographic image reconstruction apparatus reconstructs an original image when a reference beam condition and a condition of a beam irradiating unit coincide with each other in making a hologram by outputting R(λ, θ) using the light irradiating unit of which a wavelength (λ) and an angle (θ) are controlled and irradiating the made hologram.

FIG. 8 is a flowchart illustrating a process in which an authenticity judging unit of the holographic image reconstruction apparatus judges whether a holographic image is forged according to an embodiment of the present invention.

FIG. 9 is a diagram for describing a process in which a holographic image reconstruction apparatus generates a holographic image including multiple images according to another embodiment of the present invention.

FIG. 10 is a diagram for describing a process in which the holographic image reconstruction apparatus selectively reconstructs at least any one of holographic images including multiple images according to another embodiment of the present invention.

FIG. 11A is a conceptual diagram for describing a control method of a reference beam angle θ_{R}.

FIG. 11B is a side view in which a film laid horizontally is viewed from the side.

FIG. 11C is a side view in which a film erected vertically is viewed from the side.

### DETAILED DESCRIPTION OF THE EMBODIMENTS

The present invention may have various modifications and various embodiments and specific embodiments will be illustrated in the drawings and described in detail.

However, this does not limit the present invention within specific embodiments, and it should be understood that the present invention covers all the modifications, equivalents and replacements within the idea and technical scope of the present invention.

Terminologies such as first or second may be used to describe various components but the components are not limited by the above terminologies. The above terminologies are used only to discriminate one component from the other component. For example, without departing from the scope of the present invention, a first component may be referred to as a second component, and similarly, a second component may be referred to as a first component. A terminology such as and/or includes a combination of a plurality of associated items or any item of the plurality of associated items.

It should be understood that, when it is described that an element is “coupled” or “connected” to another element, the element may be “directly coupled” or “directly connected” to the another element or “coupled” or “connected” to the another element through a third element. In contrast, it should be understood that, when it is described that an element is “directly coupled” or “directly connected” to another element, it is understood that no element is not present between the element and the another element.

Terms used in the present application are used only to describe specific embodiments, and are not intended to limit the present invention. A singular form may include a plural form if there is no clearly opposite meaning in the context. In the present application, it should be understood that term “include” indicates that a feature, a number, a step, an operation, a component, a part or the combination thereof described in the specification is present, but does not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if it is not clearly defined in the present invention.

Hereinafter, a preferred embodiment of the present invention will be described in more detail with reference to the accompanying drawings. In describing the present invention, like reference numerals refer to like elements for easy overall understanding and a duplicated description of like elements will be omitted.

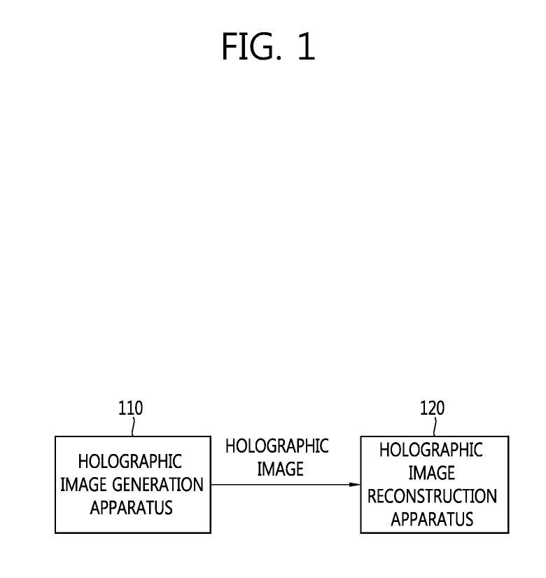

FIG. 1 is a block diagram illustrating a holographic image authenticity identification system according to an embodiment of the present invention. As illustrated in FIG. 1, a holographic image authenticity identification system according to an embodiment of the present invention may include a holographic image generation apparatus 110 and a holographic image reconstruction apparatus 120.

Referring to FIG. 1, the holographic image generation apparatus 110 may generate a holographic image by making a characteristic in which an image is changed depending on an illumination characteristic to a reference beam used in making a hologram in order to prevent the made holographic image from being forged through replication or copying. The holographic image generation apparatus 110 generates an object beam based on an original image and irradiates the generated object beam to a recording material (for example, may be a film). Herein, the reference beam is irradiated at an appropriate angle and an appropriate wavelength to make the holographic image. In this case, the original image may be a moving picture or a still image. The holographic image reconstruction apparatus 120 may judge whether the generated holographic image is forged. The holographic image generation apparatus 110 may transmit information associated with an irradiation characteristic of the reference beam used in making to the holographic image reconstruction apparatus 120 in order to help the holographic image reconstruction apparatus 120 judge whether the generated holographic image is forged. This may be achieved by a wired/wireless network (not illustrated). In some cases, a user reference beam inputs associated information in the holographic image reconstruction apparatus 120 personally to achieve the transmission. Moreover, the holographic image generation apparatus 110 may transmit information on the original image (for example, a recorded image) to the holographic image reconstruction apparatus 120 in order to assist comparing the original image with the holographic image reconstructed by an illumination in the holographic image reconstruction apparatus 120.

The holographic image reconstruction apparatus 120 may identify whether a target holographic image is forged. The holographic image reconstruction apparatus 120 may irradiate a beam having the same characteristic as the irradiation characteristic of the reference beam used when the holographic image generation apparatus 110 makes the holographic image to the target holographic image, in order to identify whether the target holographic image is forged. In this case, the irradiation characteristic of the reference beam may be determined by an irradiation angle between the reference beam and the recording material and a wavelength of the reference beam. Further, information on the irradiation characteristic of the reference beam may be acquired from the holographic image generation apparatus 110 by wired/wireless communication. The holographic image reconstruction apparatus 120 irradiates a beam having the same characteristic as the reference beam to the target holographic image to reconstruct the holographic image. Herein, a term “reconstruction” may be used as a concept including outputting, observation, and the like of an image. The holographic image reconstruction apparatus 120 acquires the reconstructed holographic image through a camera, and the like and judges the similarity between the acquired image and the original image by comparing the acquired image with the original image to judge whether the acquired image is forged. In this case, information on the original image may be acquired form the holographic image generation apparatus 110. Alternatively, the output original image may be captured and acquired.

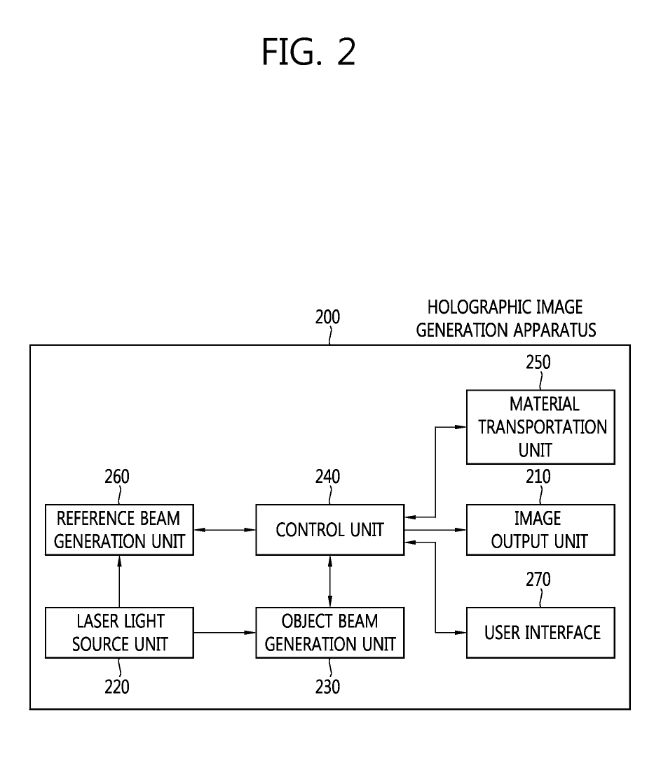

FIG. 2 is a block diagram schematically illustrating a configuration of a holographic image reconstruction apparatus according to an embodiment of the present invention. As illustrated in FIG. 2, a holographic image generation apparatus 200 may include an image output unit 210, a laser light source unit 220, an object beam generation unit 230, a control unit 240, a material transportation unit 250, a reference beam generation unit 260, and a user interface 270.

Referring to FIG. 2, the image output unit 210 outputs an image to be made by a hologram. Herein, the output image is generated to a modulated object beam to be recorded in a recording material.

The laser light source unit 220 may generate a laser beam having a desired wavelength characteristic by selecting a desired wavelength for lasers having various wavelengths by using a shutter, a wave plate and a polarizer, a filter and a beam combiner, and the like and controlling the intensity of each wavelength. Further, the laser light source unit may perform even a function to expand the laser beam and generate a collimated beam. The generated beam is provided to the object beam generation unit 230 to form the object beam and provided to the reference beam generation unit 260 to form the reference beam.

The object beam generation unit 230 may generate the object beam and converge and irradiate the generated object beam in the recording material, based on the laser beam provided from the laser light source unit 220 and an image output from the image output unit 210. In more detail, the object beam generation unit 230 may perform a function to generate an object beam modulated depending on an image loaded to a spatial light modulator (SLM) which is a spatial light modulator and a function to converge and irradiate the object beam on the recording material (for example, a holographic film) through a converging lens which is an objective lens.

The control unit 240 may control the image output unit 210, the laser light source unit 220, the object beam generation unit 230, the material transportation unit 250, and the reference beam generation unit 260. The control unit 240 may control the image output unit 210 to output a recorded image to generate the holographic image. Further, the control unit 240 may control a characteristic (for example, a wavelength) of the laser beam by controlling the laser light source unit 220. The control unit 240 may control a movement speed of the recording material by controlling the material transportation unit 250. The control unit 240 may control the irradiation angle and the wavelength characteristic of the reference beam for generating the holographic image by controlling the reference beam generation unit 260. The characteristic information may be stored in a data storage unit (for example, an RAM/ROM or other storages) (not illustrated) and in some cases, the characteristic information may be transmitted to other apparatuses through a communication unit (not illustrated).

The material transportation unit (translation stage) 250 performs a function to accurately photosense the object beam and the reference beam at a desired film (material) position by transporting the hologram recording material.

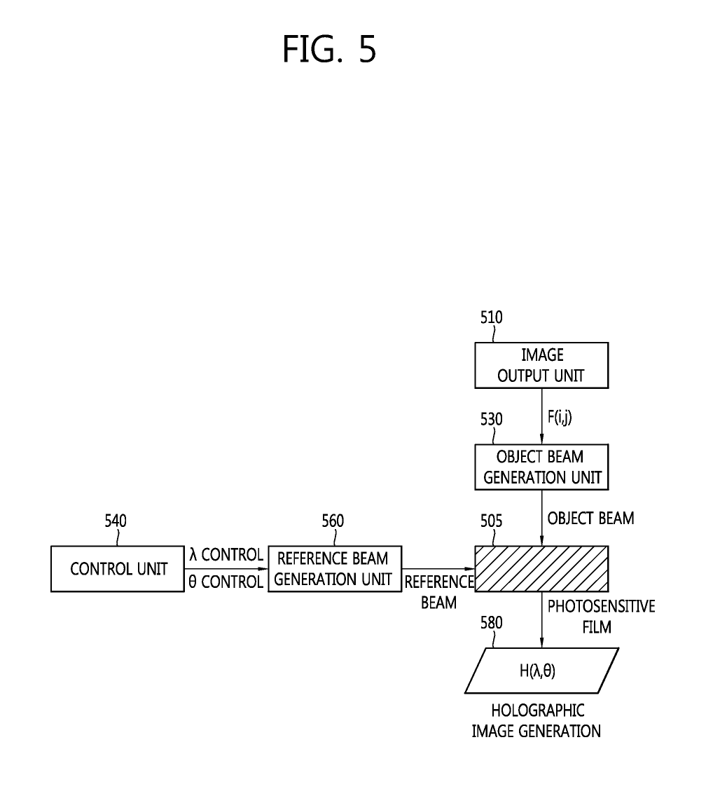

The reference beam generation unit 260 makes the reference beam be incident in the recording material (for example, the holographic film) at a desired angle by controlling a wavelength of the collimated beam generated by the laser light source unit 220 and the intensity of the beam for each wavelength to perform a function to form an interference fringe between the object beam and the reference beam. In this case, since a holographic image may be generated, which has a different interference fringe depending on the wavelength and the irradiation angle of the reference beam which is incident and becomes an important characteristic in determining whether the holographic image is forged at the time of reconstructing the holographic image, a reference beam control characteristic needs to be precisely controlled by the control unit 240 and related information may be stored in the data storage unit. This may be determined by a predetermined wavelength and a predetermined irradiation angle. Hereinafter, a function to control the wavelength and the irradiation angle of the reference beam will be described in detail with reference to FIG. 5.

The user interface 270 receives an input from the user and provides the received input to the control unit 240. The user may input information on a desired image. Further, information associated with a change of a user's set-up of the reference beam control characteristic may be input by the user.

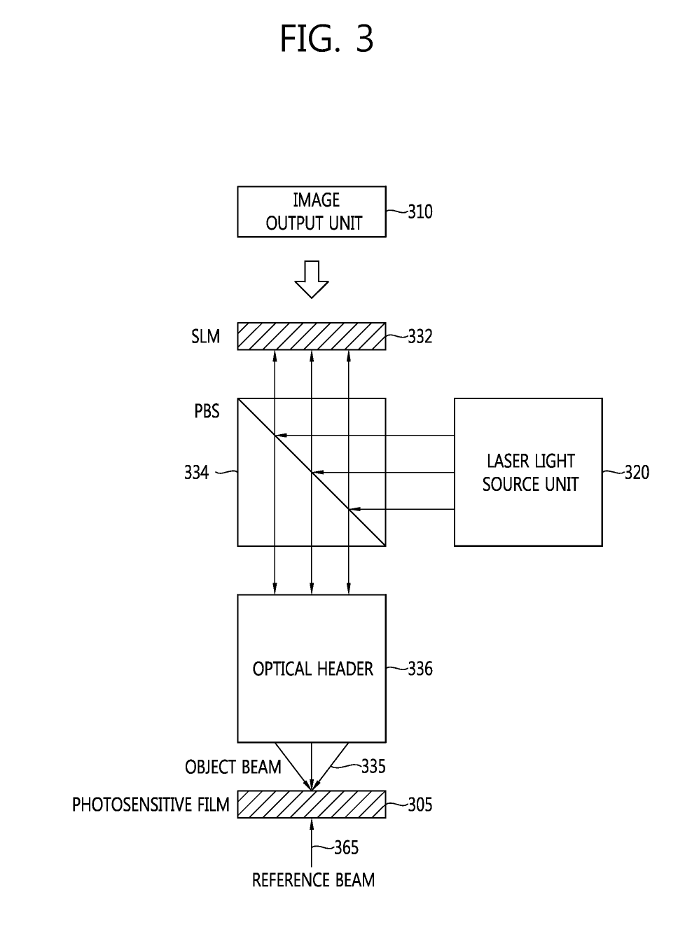

FIG. 3 is a conceptual diagram for describing a process in which a laser parallel beam is irradiated to a photosensitive film.

Referring to FIG. 3, a structure that irradiates an object beam 335 in the holographic image generation apparatus 200 may include a light spatial modulator (SLM) 332, a polarization beam splitter (PBS) 334, and an optical header 336. An image output from an image output unit 310 is provided to the light SLM 332 for generating the object beam 335 to be provided toward the optical header 336. A laser collimated beam generated by a laser light source unit 320 is provided PBS 334 to be divided and provided toward the SLM 332 and the optical header 336. The optical header 336 receives a laser beam provided through the PBS, and converges the received laser beam to record the converged laser beam on a photosensitive film 305. The optical header 336 may be constituted by lenses and the object beam 335 may be converged and recorded on the photosensitive film 305 mounted on a material transportation unit (not illustrated). In this case, the object beam 335 is irradiated and a reference beam 365 may be output through a reference beam generation unit (not illustrated). An irradiation angle and a wavelength characteristic of the reference beam serves as an important role in generating a holographic image.

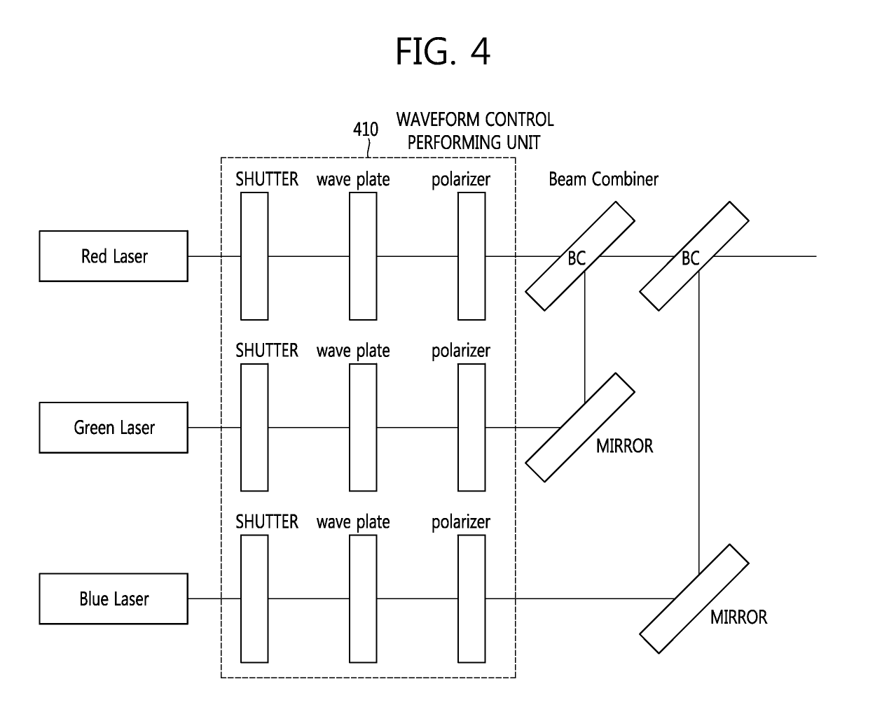

FIG. 4 is a conceptual diagram for describing an operation of the laser light source unit 220 (see FIG. 2) according to an embodiment of the present invention.

The laser light source unit 220 may primarily include red, green, and blue lasers. The respective lasers are transmitted to each of the object beam generation unit 230 and the reference beam generation unit 260 through a BS which is a beam splitter. Constitutions of each of the object beam generation unit 230 and the reference beam generation unit 260 may control select a desired wavelength and the intensity of each wavelength. The constitutions will be described below.

A wavelength control performing unit 410 that controls a part associated with the wavelength may include a shutter, a wave plate, and a polarizer. In detail, the wavelength control performing unit 410 may selectively perform opening and shielding functions for lasers having various wavelengths such as red, green, and blue by means of the shutter. As a result, it may be determined whether a corresponding wavelength band is used. The intensity of an output beam may be determined by using the wave plate and the polarizer.

The wavelength-controlled beam may determine an optical path through a mirror and beams having various wavelengths may be collected into one by using a beam combiner, and the like to output the corresponding beam. A desired wavelength may be selected and the intensity of each wavelength may be controlled and a laser beam having desired wavelength and intensity characteristics may be generated, through such a process. According to another embodiment of the present invention, the shutter, the wave plate, and the polarizer are connected to the respective lasers to be controlled, respectively.

FIG. 5 is a diagram for describing a function to control a wavelength (λ) of a reference beam and an angle (θ) with a material of the reference beam.

Referring to FIG. 5, when the holographic image is made, a constitution for controlling the wavelength is described in FIG. 4, and a constitution for controlling the angle controls the angle through controlling linear and rotational displacements after the mirror is mounted on linear and rotation stages. Further, a Galvano mirror may be used in order to control the angle. An output laser L may be a laser L(λ, θ) which is changed depending on a wavelength (λ) and an angle (θ).

In a process of generating the holographic image, an image F(i, j) output through an image output unit 510 is input into a spatial light modulator (SLM) of an object beam generation unit 520 to output modulated light encoded with an appropriate image brightness value. The object wave generation unit 520 converges and irradiates the output modulated light onto a holographic image photosensitive film 505.

A reference beam generation unit 560 may generate a reference beam laser L(λ, θ) of which a wavelength (λ) and an angle (θ) are controlled by a control unit 540. The object beam interferes with the generated laser L(λ, θ) and image F(i, j) to generate the interference fringe and the interference fringe is recorded in the photosensitive film 505, and as a result, a holographic image 580 H(λ, θ) may be finally generated. The holographic image may be expressed as H(λ, θ)=F(i, j)*L(λ, θ). The holographic image reconstruction apparatus may determine whether the generated holographic image is forged.

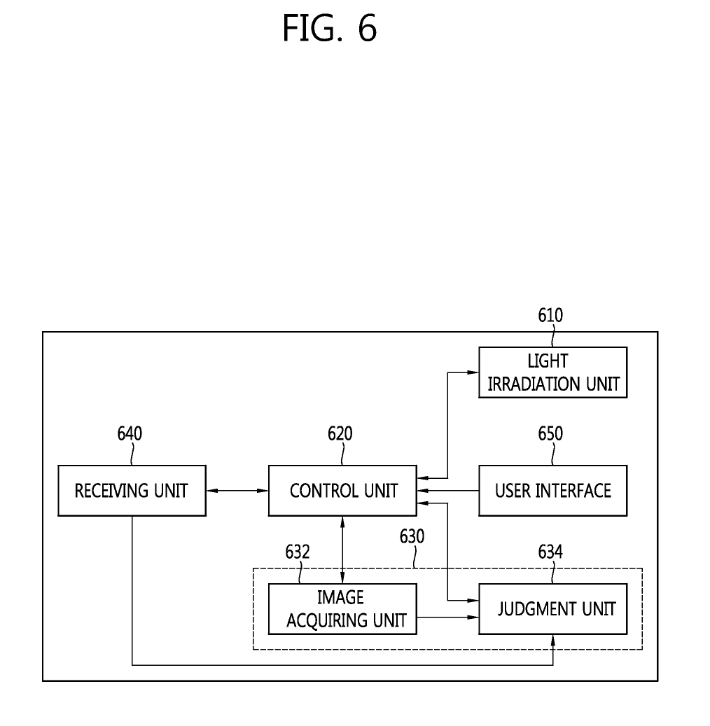

FIG. 6 is a block diagram schematically illustrating a configuration of a holographic image reconstruction apparatus according to an embodiment of the present invention. As illustrated in FIG. 6, a holographic image reconstruction apparatus 600 according to an embodiment of the present invention may include a light irradiation unit 610, a control unit 620, an authenticity judgment unit 630, a receiving unit 640, and a user interface 650.

Referring to FIG. 6, the light irradiation unit 610 irradiates light to a target hologram of which forgery or not is to be determined. The light irradiation unit 610 may be an illumination device. The light irradiation unit 610 may control a characteristic of light irradiated under a control by the control unit 620.

The control unit 620 may control the light irradiation unit 610, the authenticity judgment unit 630, and the receiving unit 640. The control unit 620 may control the light irradiation characteristic of the light irradiation unit 610 based on reference beam characteristic information received through the receiving unit 640. The control unit 620 may control the light irradiation unit 610 to irradiate the same light to the holographic image based on information associated with the wavelength and the irradiation angle of the reference beam used in making the holographic image.

The authenticity judgment unit 630 may include an image acquiring unit 632 and a judgment unit 634. The image acquiring unit 632 may acquire a shape of the target holographic image reconstructed by irradiating light through the camera, and the like. The image acquiring unit 632 may include at least one of a CCD element, a CCD camera, a stereo camera, and multiple cameras (two or more horizontally placed camera groups). The image acquiring unit 632 may be used to acquire original image information. For example, the reconstructed target holographic image or the original image may be acquired by using the CCD element or the CCD camera. Since the reconstructed target holographic image may be reconstructed differently depending on the characteristic of the irradiated light, it may be determined whether the image is forged by acquiring the reconstructed image when the same light as the reference beam is irradiated.

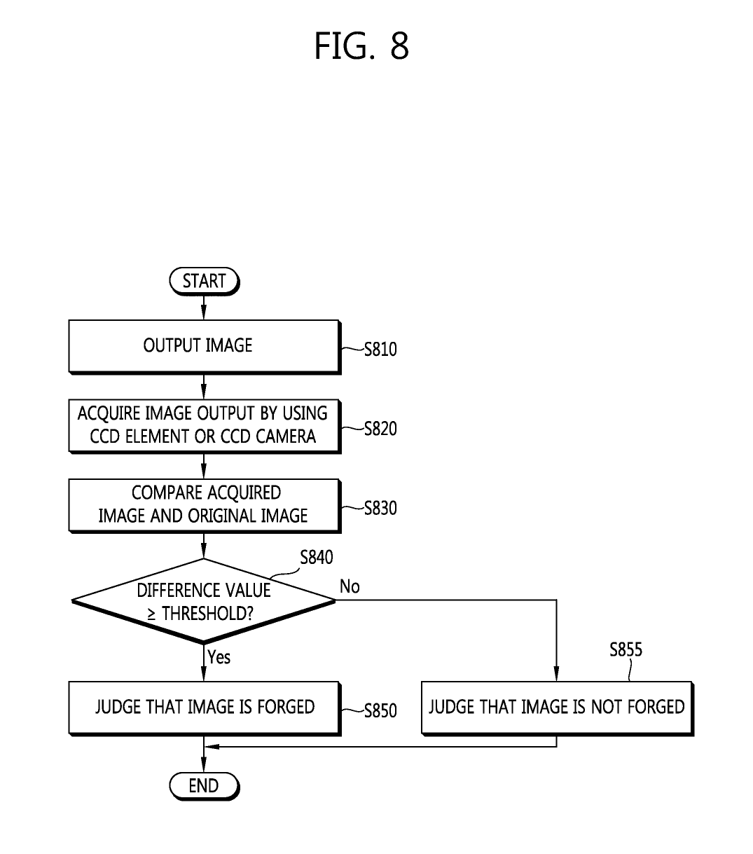

The judgment unit 634 compares the reconstructed holographic image acquired through the image acquiring unit 632 with the original image to judge whether the holographic image is forged. A detailed description will be described below with reference to FIG. 8. The judgment unit 634 may receive original image information from the receiving unit 640.

The receiving unit 640 may receive information from the outside. The receiving unit 640 may receive the reference beam characteristic information from the holographic image generation apparatus or other apparatuses. Herein, the other apparatuses may be apparatuses such as a server, and the like, which manage the reference beam characteristic information corresponding to a specific image. Further, the receiving unit 640 may receive from the holographic image generation apparatus or other apparatuses original image information required to determine whether the specific image is forged. In this case, apparatuses that receive the reference beam characteristic information and the original image information need not particularly be the same as each other. Information may be received from different databases. The receiving unit 640 may transmit the received information to the control unit 620 or the judgment unit 634. A transmitting unit (not illustrated) corresponding to the receiving unit 640 may transmit an information request signal to the holographic image generation apparatus or other apparatuses in order to acquire the reference beam characteristic information or the original image information. In some cases, as described above, the original image information may be acquired through the image acquiring unit 632.

The user interface 650 may be used to change a user's set-up associated with reconstruction of the hologram. The user interface 650 may change the user's set-up by receiving an input from the user. The user may input the reference beam characteristic information personally and the information input through the user interface 650 may be transmitted to the control unit 620. Further, the user may change a reference value for judging whether the specific image is authentic, which is used in the judgment unit 634 through the user interface 650.

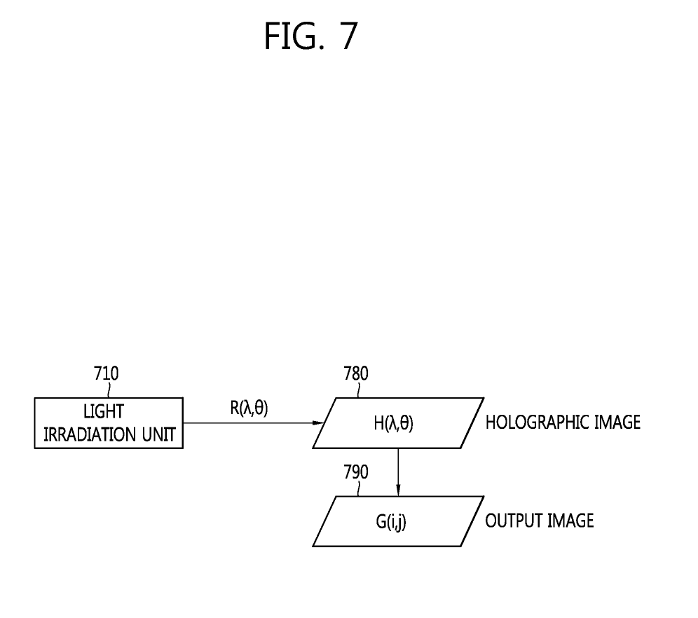

FIG. 7 is a diagram for describing a process in which a holographic image reconstruction apparatus reconstructs an original image when a reference beam condition and a condition of a beam irradiating unit coincide with each other in making a hologram by outputting R(λ, θ) using the light irradiating unit of which a wavelength (λ) and an angle (θ) are controlled and irradiating the made hologram.

Referring to FIG. 7, a light irradiation unit 710 irradiates R(λ, θ) to a target holographic image 780 H(λ, θ) generated through the process of FIG. 5. The light R(λ, θ) irradiated herein, may be an illumination in which a characteristic of an irradiation angle or a wavelength of light is controlled. A control unit (not illustrated) controls a wavelength (λ) and an irradiation angle (θ) of the light irradiation unit 710 based on characteristic information of a reference beam used in making the holographic image 780 to irradiate the same light as the reference beam. The holographic image 780 H(λ, θ) is irradiated with the light R(λ, θ) to be reconstructed as an output image G(i, j). In addition, the reconstructed image G(i, j) may be acquired through an image acquiring unit (not illustrated).

FIG. 8 is a flowchart illustrating a process in which an authenticity judging unit of the holographic image reconstruction apparatus judges whether a holographic image is forged according to an embodiment of the present invention.

Referring to FIG. 8, first, a holographic image reconstruction apparatus irradiates light having the same characteristic as a reference beam used in making a holographic image to a holographic image to output the holographic image (S810). In addition, an image output by using a CCD element or a CCD camera is acquired (S820). In this case, an image may be acquired by using a stereo camera or multiple cameras. In some cases, an original image which is reconstructed outside or directly may be acquired. In addition, the acquired holographic image and the original image are compared with each other (S830). The image may be compared with each other based on at least any one of depth information, object occlusion information, and feature point information of an acquired target holographic image. For example, a judgment unit may compare both images by a method of finding a depth or range value of a feature point in the image acquired by the stereo camera or the multiple cameras or determine both images by a method of identifying inter-depth or range values or an inter-placement relationship of various feature points. By other methods, it may determined whether both images are the same as each other by using a feature point viewed only at a specific observation angle by occlusion by a front object.

According to a result of the image comparison, when a difference value is equal to or more than a reference value (threshold) (S840), it may be judged that the acquired image is forged (S850) and if not, it may be judged that the acquired image is not forged (S855). That is, when similarity (a degree in which both images are the same as each other) is equal to or more than the reference value, it is judged that both images are the same as each other to judge that the acquired image is not forged and when the similarity is equal to or less than the reference value, both images are not the same as each other to judge that the acquired image is forged. The reference value for the difference value or the reference value for the similarity may be changed through a user's set-up.

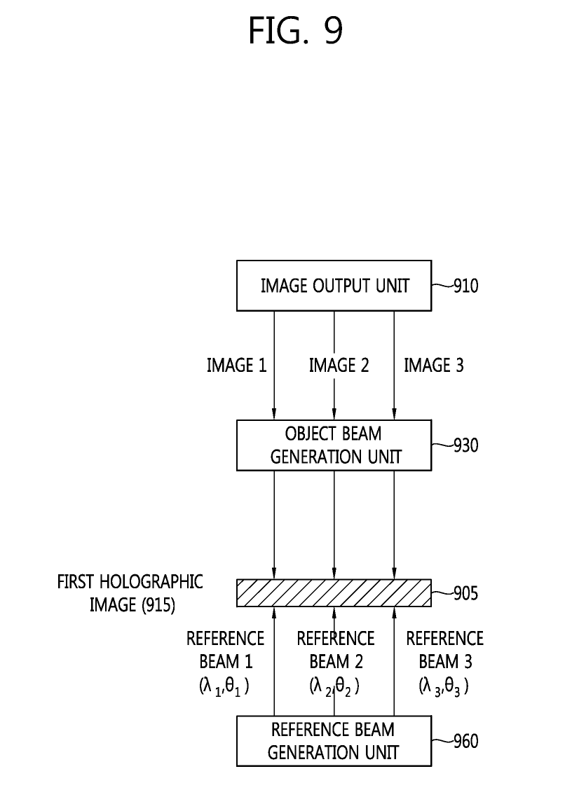

FIG. 9 is a diagram for describing a process in which a holographic image reconstruction apparatus generates a holographic image including multiple images according to another embodiment of the present invention.

Referring to FIG. 9, an image output unit 910 may output a plurality of images (for example, image 1, image 2, and image 3) and provide the output images to an object beam generation unit 930. The object beam generation unit 930 generates object beams based on the plurality of images (for example, image 1, image 2, and image 30 to converge the generated object beam on a photosensitive lens 905. In this case, reference beams that cause interference in the respective images (for example, image 1, image, 2, image 3, and the like), respectively may be controlled to have different characteristics. A distribution of irradiation angle and wavelengths of the reference beams may be set in advance and a desired image may be thus selected at a reconstruction side. The reference beam generation unit 960 generates reference beams corresponding to the images, respectively, but may make the characteristics of the reference beams be different from each other. For example, reference beam 1 provided to image 1 may be configured to have wavelength λ₁ and an angle θ₁ of light irradiated to a photosensitive film, reference beam 2 provided to image 2 may be configured to have wavelength λ₂ and an angle θ₂, and reference beam 3 provided to image 3 may be configured to have a wavelength λ₃ and an angle θ₃, and herein, λ₁, λ₂, and λ₃ are not the same as each other and θ₁, θ₂, and θ₃ may be configured to have different values from each other. A reason for making the difference reference beams to correspond to each other is to selectively reconstruct images corresponded when different beams are irradiated in terms of reconstruction. A first holographic image 915 including image 1, image 2, and image 3, that is, multiple images may be generated by irradiating the reference beams having different characteristics. The generated first holographic image 915 may be provided to the holographic image reconstruction apparatus. The reference beam characteristic information may also be provided.

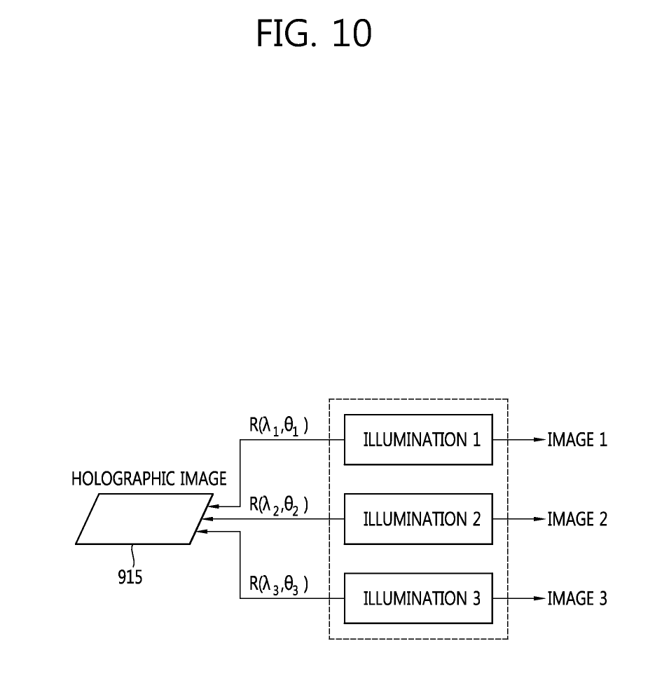

FIG. 10 is a diagram for describing a process in which the holographic image reconstruction apparatus selectively reconstructs at least any one of holographic images including multiple images according to another embodiment of the present invention.

Referring to FIG. 10, the holographic image reconstruction apparatus may include a component (may be, for example, an illumination) irradiating light, a component controlling a direction of the illumination, and a component selecting a wavelength. The holographic image reconstruction apparatus irradiates different illuminations to the first holographic image 915 including at least one image (including image 1, image 2, and image 3 in the embodiment) to selectively reconstruct images corresponding to the respective illuminations. For example, when illumination 1 has the wavelength λ₁ and the irradiation angle θ₁, image 1 may be reconstructed. Similarly, when illumination 2 has the wavelength λ₂ and the irradiation angle θ₂ and illumination 2 irradiates light having the wavelength λ₃ and the irradiation angle θ₃, image 2 and image 3 may be selectively reconstructed. The holographic image apparatus needs to have information on the reference beam used in making an image and the reference bean information may be acquired from the holographic image generation apparatus or other apparatuses. Alternatively, the reference beam information may be input through the user interface. Alternatively, the reference beam of the holographic image generation apparatus and the irradiation angle and wavelength characteristics of the holographic image reconstruction device to enable selective image reconstruction without additional information transmission and reception.

In some cases, when the holographic image reconstruction apparatus receives a reconstruction request of a specific image through the user interface, the holographic image reconstruction apparatus may control the requested image to be reconstructed by automatically irradiating an illumination having an irradiation angle and a wavelength corresponding to the specific image to a first holographic image. For example, when the user requests reconstructing image 2, a control unit (not illustrated) controls an illumination corresponding to an irradiation characteristic of a reference beam used in making image 2 to the first holographic image to selectively reconstruct image 2.

According to yet another embodiment of the present invention, the image selectively reconstructed based on characteristic information of the reference beam used in making the first holographic image is compared with the original image to determine whether the holographic image is forged. For example, a specific angle or a specific angle characteristic may be used as means for identifying whether the holographic image is forged.

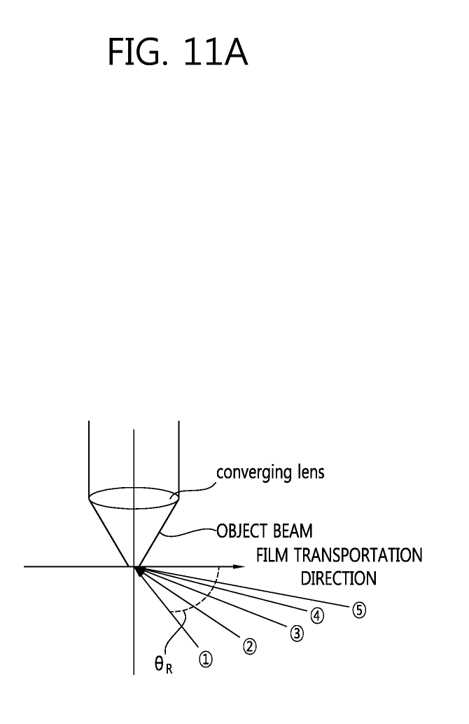

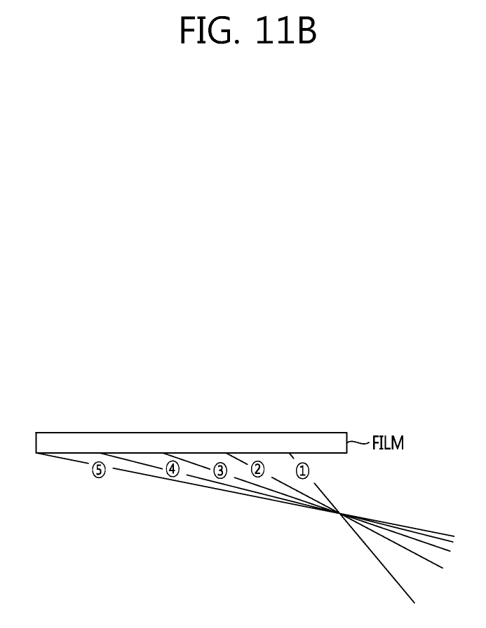

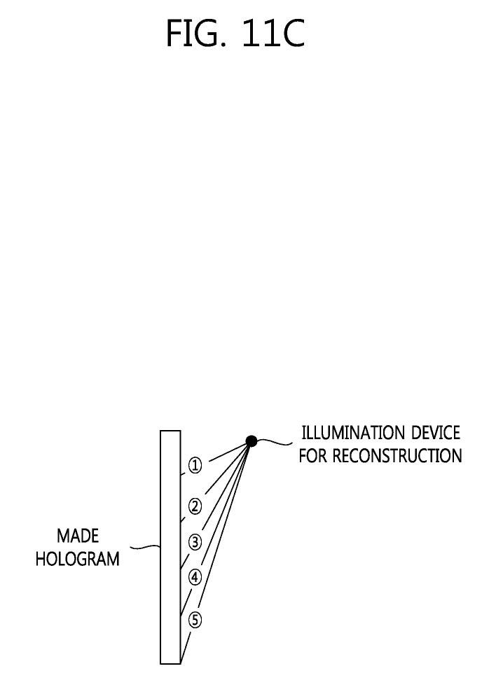

FIG. 11A is a conceptual diagram for describing a control method of a reference beam angle θ_{R}. FIG. 11B is a side view in which a film laid horizontally is viewed from the side. FIG. 11C is a side view in which a film erected vertically is viewed from the side.

Referring to FIGS. 11A, 11B, and 11C, according to an embodiment of the present invention, when the material transportation unit is operated by a method in which a film is transported in an arrow direction, reference beams illustrated in FIG. 11A need to be irradiated in the order of numbers (Nos. 1 to 5) as illustrated in FIG. 11C (the side view in which the film erected vertically is viewed from the side). That is, when the film has been transported and recording is thus terminated, the reference beam is irradiated as illustrated in FIG. 11B (the side view in which the film laid horizontally is viewed from the side), and as a result, recording of Nos. 1 to 5 is the same as an illumination direction (when it is assumed that the reference beam is a point light source). Therefore, the recording is completely reconstructed to observe an image at the position. In this case, when the illumination is irradiated in different reference beam directions of some of Nos. 1 to 5 in recording, the recording of Nos. 1 to 5 may not be reconstructed by the illumination of FIG. 11C. Accordingly, the element regarding the reconstruction is coded may be used as an identification method.

While the invention has been shown and described with respect to the preferred embodiments, it will be understood by those skilled in the art that various changes and modifications may be made without departing from the spirit and scope of the invention as defined in the following claims.

What is claimed is:

1. An apparatus for identifying authenticity of a holographic image, wherein:
the authenticity is identified by comparing a holographic image reconstructed by irradiating light having the same characteristic as an irradiation characteristic of a first reference beam used in generating the holographic image with an original image.

2. The apparatus of claim 1, comprising:
a light irradiation unit reconstructing the holographic image by irradiating light to the holographic image;
a control unit controlling an irradiation characteristic of the light irradiated to the holographic image; and
an authenticity judging unit judging the authenticity by comparing the reconstructed holographic image with the original image.

3. The apparatus of claim 2, wherein the control unit controls light having the same irradiation angle and wavelength as the first reference beam to a recording material to the holographic image.

4. The apparatus of claim 2, wherein the authenticity judging unit includes:
an reconstructed image acquiring unit acquiring the reconstructed holographic image; and
a judgment unit judging the authenticity of the holographic image by judging whether similarity between the acquired holographic image and the original image is equal to or more than a reference value.

5. The apparatus of claim 4, wherein the judgment unit judges the authenticity based on at least one of depth information of the acquired holographic image, object occlusion associated information, and feature point information.

6. The apparatus of claim 5, wherein the judgment unit judges the authenticity of the holographic image by detecting a depth value of a feature point in the acquired holographic image or determines the authenticity of the holographic image based on inter-depth values or inter-placement relationship of a plurality of feature points.

7. A method for identifying authenticity of a holographic image, the method comprising:
identifying the authenticity by comparing a holographic image reconstructed by irradiating light having the same characteristic as a characteristic of a first reference beam used in generating the holographic image with an original hologram image.

8. An apparatus for selectively reconstructing a first holographic image including a plurality of holographic images, wherein:
at least one holographic image among the plurality of holographic images is selectively reconstructed by irradiating light by using light irradiation means capable of an irradiation angle and a wavelength of light to a first holographic image generated by using reference beams having different characteristics with respect to a plurality of original images.

9. The apparatus of claim 8, comprising:
a light irradiation unit reconstructing the holographic image by irradiating light to the holographic image; and
a control unit controlling an irradiation characteristic of the light irradiated to the holographic image,
wherein the control unit controls an irradiation angle and a wavelength of light irradiated to correspond to an irradiation angle and a wavelength of at least one reference beam among the plurality of holographic images included in the first holographic image.

10. The apparatus of claim 9, wherein information associated with the irradiation angle and the wavelength of the reference beam is received from the outside or input through a user interface and an irradiation angle and a wavelength of light are controlled based on the received or input information.

11. The apparatus of claim 8, wherein an element associated with reconstruction of the holographic image is coded to be provided as image identification information.

12. The apparatus of claim 8, wherein the authenticity is identified by comparing a holographic image reconstructed by irradiating light having the same characteristic as an irradiation characteristic of a reference beam used in generating the first holographic image with an original image.

13. A method for selectively reconstructing a first holographic image including a plurality of holographic images, comprising:
selectively reconstructing at least one holographic image among the plurality of holographic images by irradiating light by using light irradiation means capable of an irradiation angle and a wavelength of light to a first holographic image generated by using reference beams having different characteristics with respect to a plurality of original images.

14. A system for selectively reconstructing a first holographic image including a plurality of holographic images, comprising:
a holographic image generation apparatus generating a first holographic image by using reference beams having different characteristics with respect to a plurality of original images; and
a holographic image reconstruction apparatus selectively reconstructing at least one holographic image among the plurality of holographic images by irradiating light by using light irradiation means capable of controlling an irradiation angle and a wavelength of light with respect to the generated first holographic image.

15. The system of claim 14, wherein the holographic image generation apparatus provides characteristic information of reference beams used in the plurality of original images to the holographic image reconstruction apparatus and the holographic image reconstruction apparatus controls an irradiation angle and a wavelength of light irradiated to a holographic image based on the reference beam characteristic information.

16. The system of claim 15, wherein the holographic image reconstruction apparatus identifies authenticity by comparing a holographic image reconstructed by irradiating light having the same characteristic as an irradiation characteristic of a reference beam used in generating the first holographic image with an original image.
